(19) United States
(12) Patent Application Publication
(10) Pub. No.: US 2011/0030250 A1
(43) Pub. Date: Feb. 10, 2011

(54) METHOD AND APPARATUS FOR DISPLAY ARTICLES

(76) Inventor: Jennifer Herbert Dodge Boyd, Venice, FL (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/535,998

(22) Filed: Aug. 5, 2009

(51) Int. Cl. G09F 19/00

(52) U.S. Cl. 40/1

(57) ABSTRACT

Disclosed is a method and apparatus for displaying articles between at least two of the ceiling, wall and floor of a retail establishment. The display may include mounting a plurality of spaced apart cords so that the cords to extend between a floor, ceiling, and/or wall of a structure. The cords may be mounted at different angles relative to the floor or ceiling, and with each cord being mounted to a position on the floor, ceiling and/or wall that is remote from the mounting positions of another cord. An article of clothing may then be attached to selected spaced apart cords such that it is suspended between the floor and the ceiling. In addition, the article may be oriented such that at least one of a front or a back of the article is substantially fully viewable by an individual viewing the display.

### FIELD OF THE INVENTION

Disclosed is an apparatus and method for displaying articles for sale in a free form arrangement in store windows, showrooms and the like. The displayed articles may display all manner of goods, including (but not limited to) fabrics, clothing and other similar goods, footwear, handbags, umbrellas, cameras, children's toys, handheld electronic items, etc.

### BACKGROUND OF THE INVENTION

Displays of goods, including fabrics clothing or the like, in retail stores and in store windows have often taken the form of displaying clothing on manikins or on hangers. This is particularly true where it is desirable to fully display fabric or clothing as it would be seen when used (i.e., drapes) or worn (i.e., clothing). Manikins, however, are expensive and limit the way in which clothing can be displayed. Hangers are less expensive than manikins, but more severely limit the way that articles of clothing can be displayed.

### SUMMARY OF THE INVENTION

A display arrangement and method is disclosed for displaying articles, including clothing and the like, that permits the articles to be shown in an almost limitless arrangement of individual pieces and a substantially limitless array of multiple pieces. The arrangement is especially suitable for displaying articles of clothing in store windows or in the clothing departments of retail establishments. Although, it will be appreciated that all manner of goods may be displayed using the display arrangement and method.

In one embodiment, the display may include a plurality of cords, with each cord extending between and being mounted to at least two of a floor, a ceiling and a wall of a structure. An article of fabric may then be attached to selected spaced cords. The cords may extend between the floor, ceiling and wall a variety of different angles and directions relative to the floor. As a result, some cords may be orientated at the same angle and direction and others at a different angle but the same direction. Some or all the cords may also be oriented vertically.

The cords used in practicing the disclosed apparatus and method may include a wide variety of strings, ropes, flexible metal wire, or stands of polymeric materials (e.g., a transparent fishing line or the like). Moreover, in operation each cord may be mounted to a position on the floor, ceiling and/or wall that is remote from the mounting positions of another cord. However, it will be appreciated that some or all of the cords may be mounted to common mounting points. For example, one end of each cord could be mounted to a single position on the floor with the opposite end of each cord being secured to different positions on the ceiling.

When attached to two or more spaced apart cords in the display, an article of fabric or clothing may be positioned so that it is suspended above the floor in a spread out or “flowing” arrangement. The article may also be oriented so that at least the front or the back of the displayed article is generally viewable by a person looking at the display.

### BRIEF DESCRIPTION OF THE DRAWINGS

A better understanding of the disclosed method and apparatus can be had upon reference to the associated drawings, wherein like reference numerals refer to like parts throughout, and wherein:

FIG. 1 is a front perspective view showing a display constructed in accordance with the disclosed method and apparatus as it may be used in a storefront window; and

FIG. 2 is a front perspective view showing a display constructed in accordance with the disclosed method and apparatus as it may be used in the interior of a retail store or like structure.

### DETAILED DESCRIPTION OF THE PREFERRED EMBODIMENTS

A method and apparatus is disclosed for displaying clothing. The display may include mounting a plurality of spaced apart cords so that the cords extend between at least two of a floor, a wall (which may be a structural or temporary wall) and a ceiling of a structure, such as a retail establishment. The cords, which may be strings, ropes, wires or polymer strands, may be mounted at different angles and directions relative to the floor and/or ceiling. Each cord may also be mounted to a position on the floor and the ceiling and/or the wall that is remote from the mounting positions of another cord. A fabric article, such as an article of clothing, may then be attached to selected spaced apart cords such that the article is suspended between the floor and the ceiling. When attached to the cords, the article may also be positioned so that a front or a back of the article is substantially fully viewable by an individual viewing the display.

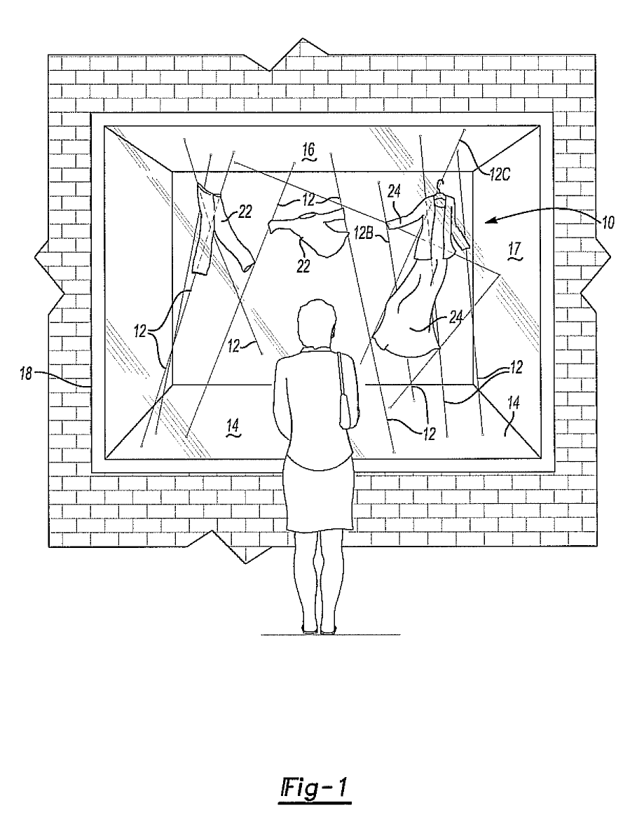

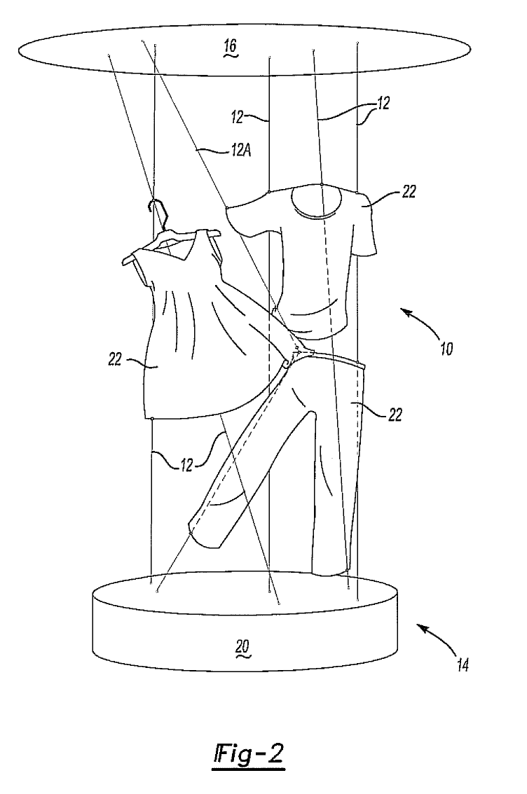

Referring now to FIGS. 1 and 2, a display 10 is shown that may include a number of cords extending between a floor 14 and a ceiling 16 and/or wall 17 of, for instance as shown in FIG. 1, the display window 18 of a retail establishment. The floor 14 (which includes, but not limited to, a pedestal 20 or riser positioned on a floor) and a ceiling 16 could also be, as shown in FIG. 2, positioned within the retail store or other structure in a position near a department offering clothing items for sale.

Still referring to FIGS. 1 and 2, the cords 12 may include strings, ropes, flexible metal wire, stands of polymeric material, and combinations thereof that extend between and are mounted to the floor 14, ceiling 16 and/or wall 17. The cords 12 may be spaced apart from each other, with some cords 12 extending substantially vertically and others extend at various angles. As best shown in FIG. 2, some or all of the cords 12A may be flexible and/or elastic. The cords 12 may also be randomly mounted to the floor 14 and the ceiling 16 to permit articles of fabric and/or clothing 22 to be displayed at various points in the display by attachment of portions of the clothing 22 to points along the cords 12.

Still referring to FIGS. 1 and 2, by attaching a sleeve 24 of a shirt or dress 26 to one of the cords 12B, and the rest of the dress 26 to another cords 12C spaced from the first cord 12B, the sleeve 22 of the dress 26 can be fully displayed and in a number of positions and arrangements. Moreover, by selecting appropriate cords 12 and attaching the article of clothing 22, 26 at selected portions of the clothing 22, 26 and on the cords 12, the article of clothing 22, 24 can be fully displayed and can even be displayed in a form that the clothing 22, 26 appears to be flying through the air.

It should be apparent the present invention provides a method of displaying clothing articles that has advantages over the presently used methods. The method employs strings appropriately positioned to enable articles of clothing to be attached to the strings to be displayed in a number of positions and arrangements. The method provides more choices in the way in which articles can be displayed than the presently used methods and does so in more economical manner than for instance the use of manikins to display the clothing. The method of the present invention also has special utility in displaying items such as articles of clothing for sale in either the store windows of retail establishments or in the clothing departments of such establishments.

Having thus described a method and apparatus for displaying articles of fabrics or the like, various other embodiments thereof will become apparent to those of skill in the art that do not depart from the scope of the following claims.

1. A display for positioning articles of fabric between the ceiling and the floor of a structure comprising;
a plurality of cords, each cord extending between and being mounted to at least two of a floor, a wall and a ceiling of a structure; and
an article of fabric attached to selected spaced cords.

2. The display of claim 1, wherein the plurality of cords extend between the floor and the ceiling at a plurality of different directions and different angles relative to the floor.

3. The display of claim 2, further comprising cords that extend substantially vertically between the floor and the ceiling.

4. The display of claim 1, further comprising cords that extend substantially vertically between the floor and the ceiling.

5. The display of claim 1, wherein each cord of the plurality of cords is mounted to a position on the floor and the ceiling that is remote from the mounting positions of another cord.

6. The display of claim 1 wherein the plurality of cords comprise a wire.

7. The display of claim 1, wherein the plurality of cords comprise a string.

8. The display of claim 1, wherein the plurality of cords comprise a transparent polymeric material.

9. The display of claim 1,comprising at least one cord that extends from the ceiling to the wall and then to the floor.

10. The display of claim 1, wherein the article of fabric is attached to at least three selected spaced cords.

11. A method of displaying articles of fabric between the ceiling and the floor of a structure comprising:
mounting a plurality of spaced apart cords to extend between a floor and a ceiling of a structure; and
attaching an article of fabric to selected spaced apart cords.

12. The method of claim 11, wherein the plurality of spaced apart cords extend between the floor and the ceiling at a plurality of different directions and different angles relative to the floor.

13. The method of claim 12, freer comprising cords that extend substantially vertically between the floor and the ceiling.

14. The method of claim 11, further comprising cords that extend substantially vertically between the floor and the ceiling.

15. The method of claim 11, wherein each cord of the plurality of spaced apart cords is mounted to a position on the floor and the ceiling that is remote from the mounting positions of another cord.

16. The method of claim 11, wherein the plurality of spaced apart cords comprise a string.

17. The method of claim 11, wherein the plurality of spaced apart cords comprise a transparent polymeric material.

18. The method of claim 11, wherein the article of fabric comprises an article of clothing.

19. The display of claim 11, wherein the article of fabric is attached to at least three selected spaced cords.

20. A method of displaying clothing between the ceiling and the floor of a retail establishment comprising:
mounting a plurality of spaced apart cords to extend between at least two of a floor, a ceiling and a wall of a structure at a plurality of different angles relative to the floor, with each cord of the plurality of spaced apart cords being mounted to a position on the floor and the ceiling that is remote from the mounting positions of another cord; and
attaching an article of clothing to at least two of the spaced apart cords so that the article of clothing is suspended between the floor and the ceiling and so that at least one of a front or a back of the article of clothing is substantially fully viewable by an individual viewing the article of clothing.
